(19) United States
(12) Patent Application Publication
(10) Pub. No.: US 2021/0299675 A1
(43) Pub. Date: Sep. 30, 2021

(54) FIELD-FLOW FRACTIONATION DEVICE

(71) Applicant: SHIMADZU CORPORATION, Kyoto-shi, Kyoto (JP)

(72) Inventors: Shigeyoshi HORIIKE, Kyoto-shi, Kyoto (JP); Yukio OIKAWA, Kyoto-shi, Kyoto (JP); Maiko NAKAYA, Kyoto-shi, Kyoto (JP)

(73) Assignee: SHIMADZU CORPORATION, Kyoto-shi, Kyoto (JP)

(21) Appl. No.: 17/260,372

(22) PCT Filed: Jul. 5, 2019
(86) PCT No.: PCT/JP2019/026786

§ 371 Date: Jan. 14, 2021

(30) Foreign Application Priority Data
Jul. 17, 2018 (JP) 2018-133826

(51) Int. Cl. B03B 5/62; B01L 3/00

(52) U.S. Cl. CPC B03B 5/62; G01N 15/10; B01L 3/502

(57) ABSTRACT

A separation cell includes a separation channel forming chip and a discharge channel forming chip. The separation cell includes a separation channel forming plate that is provided on the separation channel forming chip and has a flat surface defining a separation channel having a longitudinal direction, a discharge channel forming plate that is provided on the discharge channel forming chip and has a flat surface defining a discharge channel extending along a longitudinal direction of the separation channel, a separation membrane that is provided on the flat surface defining the separation channel on the separation channel forming chip, and is for selectively allowing a carrier fluid to permeate, a porous support plate and is attached to block an opening of the discharge channel, and a positioning structure for positioning the separation channel forming chip and the discharge channel forming chip in a specific geometrical relationship with respect to each other.

### TECHNICAL FIELD

The present invention relates to a field-flow fractionation device that separates and fractionates fine particles contained in a fluid by using field-flow fractionation (FFF).

### BACKGROUND ART

As a method for separating and detecting or fractionating fine particles having a particle size in a wide range of about 1 nm to 50 μm dispersed in a solution, what is called cross-flow type field-flow fractionation (flow field-flow fractionation: also referred to as Flow-FFF or F4) has conventionally been known (see, for example, Patent Document 1).

The cross-flow type field-flow fractionation device includes a separation cell internally having a separation channel, which is space for separating a sample. One of wall surfaces forming the separation channel in the separation cell is a porous separation membrane such as regenerated cellulose (RC) or polyether sulfone (PES), and a carrier fluid introduced into the channel passes through the separation membrane, so that a flow (cross flow) is generated in a direction perpendicular to a flow (channel flow) in a forward direction flowing from an inlet port to an outlet port of the separation channel. A discharge channel for guiding the carrier fluid that has passed through the separation membrane to a port for discharge (discharge port) is provided in the separation cell. The separation channel and the discharge channel are provided so as to face each other with the separation membrane interposed between them.

A flow (focus flow) that opposes the channel flow is formed as needed in the separation channel. A sample is introduced from the inlet port into the separation channel through a sample injector. At this time, in the separation channel, the channel flow by the carrier fluid supplied from the inlet port and the counter flow (focus flow) by the carrier fluid supplied from a port on the outlet port side different from the inlet port are formed, and the sample introduced into the separation channel is collected at a boundary portion between the channel flow and the focus flow. This is referred to as focusing.

By focusing, a difference is generated in diffusion coefficient due to a difference in hydrodynamic radius among sample particles collected in the boundary portion of the counter flow. Therefore, particles that are more easily diffused are collected on an upper side of the separation channel. This is referred to as relaxation. After that, when the focus flow is stopped and the flows in the separation channel become only the channel flow and the cross flow, particles are discharged from the separation channel through the outlet port in order from smaller particles by Stokes flow. The outlet port of the separation channel is connected to a detector such as an ultraviolet absorption detector, and, for example, a fractogram is obtained as sample particles are measured by the detector in order from sample particles having a smaller absorbance in the ultraviolet region (190 nm to 280 nm).

### PRIOR ART DOCUMENTS

### Patent Documents

Patent Document 1: Japanese Patent Laid-open Publication No. 2008-000724

### SUMMARY OF THE INVENTION

### Problems to be Solved by the Invention

The separation cell of the field-flow fractionation device described above is configured by laminating a plurality of flat plates including a separation channel forming plate for forming the separation channel and a discharge channel forming plate for forming the discharge channel. The separation channel forming plate and the discharge channel forming plate are laminated in a state where the separation membrane and a porous support plate for supporting the separation membrane are sandwiched between them. Furthermore, a sealing member such as an O-ring is sandwiched in a manner surrounding the separation membrane and the support plate between the separation channel forming plate and the discharge channel forming plate. This sealing member is for preventing the carrier fluid introduced into the separation channel from leaking to the surroundings through the separation membrane and the support plate.

In order to prevent contamination, in a case where a plurality of samples are analyzed, it is common to replace the separation membrane every time the sample changes. In order to replace the separation membrane, it is necessary to perform work of disassembling a plurality of the laminated flat plates, replacing the separation membrane sandwiched between the separation channel forming plate and the discharge channel forming plate with a new one, and then laminating and fastening the flat plates again. At this time, the flat plates are aligned with respect to each other by a method of fitting a protrusion and a hole provided on facing surfaces of the flat plates, or penetration of a bolt. However, although alignment of the separation membrane needs to be optionally performed by the user, aligning the separation membrane at a predetermined position is not easy.

The separation channel and the separation channel forming plate are preferably evenly in contact with respect to each other around a through groove forming the separation channel. However, if the position of the separation membrane is deviated from a predetermined position, a contact area between the separation channel and the separation channel forming plate becomes nonuniform, and the compressive load generated by fastening the laminated flat plates cannot be uniformly applied in the plane. For this reason, a deformation mount of the thickness of the separation membrane due to the compressive load becomes nonuniform, the flow path height of the separation channel becomes uneven, and shape deterioration may occur in the elution peak.

Further, there is a problem that, if the separation membrane is displaced to a position where the separation membrane overlaps the sealing member around the separation membrane, the flow path height of the separation channel becomes uneven or liquid leakage occurs.

In view of the above, an object of the present invention is to make it possible to easily align the separation membrane in the separation cell for the field-flow fractionation device.

### Solutions to the Problems

The separation cell targeted by the present invention is a separation cell for a field-flow fractionation device, and includes a separation channel forming chip and a discharge channel forming chip. The separation cell includes a separation channel forming plate that is provided on the separation channel forming chip and has a flat surface defining a separation channel having a longitudinal direction, a discharge channel forming plate that is provided on the discharge channel forming chip and has a flat surface defining a discharge channel extending along a longitudinal direction of the separation channel, a separation membrane that is provided on the flat surface defining the separation channel on the separation channel forming chip, is interposed between the separation channel and the discharge channel, has a size smaller than that of the separation channel forming plate and larger than that of the separation channel, is fixed to the separation channel forming plate so as to block the separation channel, and is for selectively allowing a carrier fluid to permeate, a porous support plate, is provided on the flat surface defining the discharge channel on the discharge channel forming chip, has property of allowing the carrier fluid to permeate, has a size smaller than that of the discharge channel forming plate and the same as or larger than that of the separation membrane, and is attached to block an opening of the discharge channel, and a positioning structure for positioning the separation channel forming chip and the discharge channel forming chip in a specific geometrical relationship with respect to each other. The separation channel forming chip and the discharge channel forming chip are positioned in the specific geometrical relationship by the positioning structure, so that the entire separation membrane is supported by the support plate.

The flow path height of the separation channel changes depending on the thickness of a bonded portion between the separation channel forming plate and the separation membrane. In a case where the separation channel and the separation film are bonded by an adhesive, the reproducibility of the flow path height of the separation channel deteriorates if the thickness of an adhesive layer varies. Therefore, the adhesive does not need to be interposed between the separation channel forming plate and the separation membrane. In this manner, the reproducibility of the flow path height of the separation channel can be improved.

In view of the above, as a first specific aspect of an embodiment of the separation cell according to the present invention, there is an aspect in which the separation channel forming plate and the separation membrane are adhered by molecular adhesion. Molecular adhesion is a bonding method of activating a surface of materials to be bonded by applying treatment such as corona discharge treatment to bond the materials to each other.

Further, as a second specific aspect of the embodiment of the separation cell according to the present invention, a mode in which a silicone film is interposed between the separation channel forming plate and the separation membrane can be considered. Depending on the material of the separation channel forming plate and the separation membrane, it is possible that the separation channel forming plate and the separation membrane cannot be directly bonded by molecular adhesion. In such a case, a silicone film is interposed between the separation channel forming plate and the separation membrane, and the separation channel forming plate is adhered to one surface side of the silicone film and the separation membrane is adhered to the other surface side by molecular adhesion. In this manner, the separation channel forming plate and the separation membrane can be adhered to each other without using an adhesive. Further, since the thickness of the silicone film is constant, the reproducibility of the flow path height of the separation channel is ensured.

As a third specific aspect of the embodiment of the separation cell according to the present invention, there is an aspect in which the positioning structure includes through holes for bolt penetration provided on each of the separation channel forming plate and the discharge channel forming plate and bolts penetrating the through holes, and common bolts are allowed to penetrate the through hole of each of the separation channel forming plate and the discharge channel forming plate, so that the separation channel forming chip and the discharge channel forming chip are positioned in the specific geometrical relationship with respect to each other. According to such an embodiment, the separation channel forming plate and the discharge channel forming plate are positioned so that the entire separation membrane is supported by the support plate only by allowing common bolts to penetrate the through holes provided on the separation channel forming plate and the discharge channel forming plate. Accordingly, alignment of the separation membrane can be performed accurately and easily. This third specific aspect can be carried out in combination with either one of the first specific aspect and the second specific aspect described above.

### Effects of the Invention

The separation cell for the field-flow fractionation device according to the present invention includes a separation channel forming chip and a discharge channel forming chip, and has a structure in which a separation membrane is fixed to a flat surface defining a separation channel of a separation channel forming plate having the flat surface, a support plate is attached to a flat surface defining a discharge channel of a discharge channel forming plate having the flat surface, and the separation channel forming plate and the discharging channel forming plate are positioned in a specific geometrical relationship with respect to each other by a positioning structure, so that the entire separation membrane is supported by the support plate. Accordingly, the separation membrane is automatically positioned with respect to the support plate only by positioning the separation channel forming chip and the discharge channel forming chip by the positioning structure. Therefore, the alignment of the separation membrane in the separation cell becomes easy.

### BRIEF DESCRIPTION OF THE DRAWINGS

FIG. 1 is an exploded perspective view as viewed from diagonally above to explain a structure of an embodiment of a separation cell.

FIG. 2 is a cross-sectional view of a state in which the separation cell of the embodiment is assembled.

FIG. 3 is a cross-sectional view illustrating a joint portion between a separation channel forming plate and a separation membrane of the embodiment.

### EMBODIMENT OF THE INVENTION

Hereinafter, an embodiment of a separation cell for a field-flow fractionation device will be described with reference to the drawings.

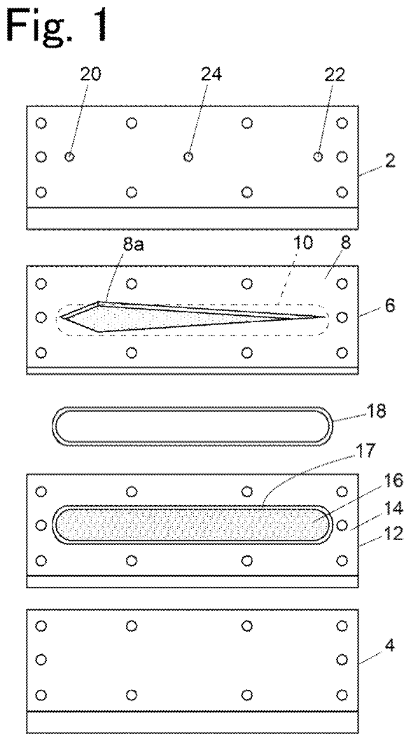

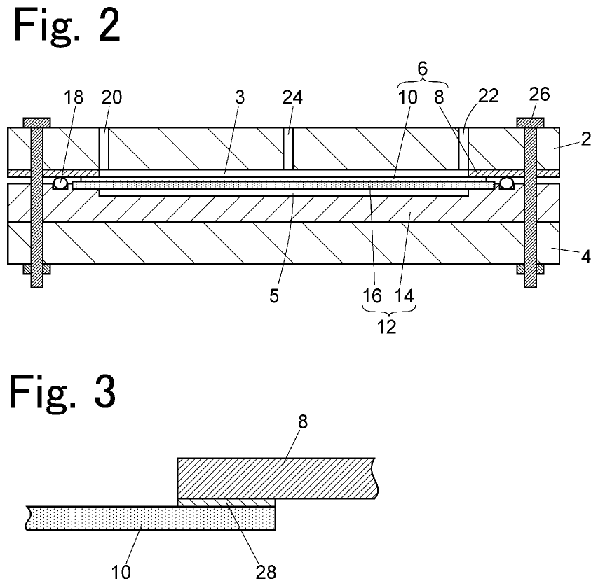

As shown in FIG. 1, the separation cell includes an upper pressing plate 2, a lower pressing plate 4, a separation channel forming chip 6, and a discharge channel forming chip 12 having a flat plate shape. Then, the separation cell is configured by lamination of the lower pressing plate 4, the discharge channel forming chip 12, the separation channel forming chip 6, and the upper pressing plate 2 in this order from the lower layer side. Through holes through which a fixing bolt 26 (see FIG. 2) penetrates are provided at positions corresponding to each other of these flat plates. Further, an O-ring 18 which is a sealing member is sandwiched between the separation channel forming chip 6 and the discharge channel forming chip 12.

The upper pressing plate 2 and the lower pressing plate are flat plate-shaped members made from, for example, aluminum. The upper pressing plate 2 is provided with through holes 20, 22, and 24 that respectively constitute an inlet port for allowing a carrier fluid or a sample to flow into a separation channel 3 (see FIG. 2) described later, an outlet port for allowing a fluid that has passed through the separation channel 3 to flow out of the separation channel 3, and an intermediate inlet port for allowing a fluid forming the focus flow to flow into the separation channel.

The separation channel forming chip 6 includes a separation channel forming plate 8 and a separation membrane 10. The separation channel forming plate 8 is a flat plate made from, for example, poly-ether-ether-ketone (PEEK) resin or polyethylene terephthalate (PET), and has a flat surface provided with a through hole 8a having a longitudinal direction. The through hole 8a serves as the separation channel 3 (see FIG. 2) described later. That is, the flat surface of the separation channel forming plate 8 provided with the through hole 8a is a flat surface that defines the separation channel 3. In the present embodiment, the through hole 8a has a substantially rhombic shape. The separation membrane 10 is a porous membrane made from RC, PES, or the like, and is smaller than the separation channel forming plate 8 and larger than the through hole 8a. The separation membrane 10 is fixed to a central portion of the flat surface (lower surface in the diagram) of the separation channel forming plate 8 so as to block one opening (opening on the lower surface in the diagram) of the through hole 8a of the separation channel forming plate 8.

The discharge channel forming chip 12 includes a discharge channel forming plate 14 and a support plate 16. Although not shown in FIG. 1, the discharge channel forming plate 14 has a flat surface facing the flat surface on which the through hole 8a of the separation channel forming plate 8 is provided, and a groove serving as a discharge channel 5 is provided on the flat surface so as to face the through hole 8a of the separation channel forming plate 14. The support plate 16 is attached to the flat surface of the discharge channel forming plate 14 so as to block an opening of the groove of the discharge channel forming plate 14. The flat surface of the discharge channel 14 on which the groove serving as the discharge channel 5 is formed is a flat surface defining the discharge channel 5.

The support plate 16 is for supporting the separation membrane 10 of the separation channel forming chip 6, and has a planar size that is substantially equal to or slightly larger than that of the separation membrane 10. The support plate 16 is a porous plate made from a sintered body or the like. The support plate 16 may be, and does not have to be, completely fixed to the discharge channel forming plate 14. A groove 17 for fitting the O-ring 18 is provided to surround the support plate 16 on the separation channel forming chip 6 side of the discharge channel forming plate 14.

FIG. 2 shows the separation cell in an assembled state.

The separation cell is configured in a manner that the flat plate-shaped separation channel forming chip 6 and the discharge channel forming chip 12 are fixed in a state of being positioned in a specific geometrical relationship with respect to each other in a state where the separation channel forming chip 6 and the discharge channel forming chip 12 are sandwiched between the upper pressing plate 2 and the lower pressing plate 4. In the present embodiment, as a positioning structure for positioning the separation channel forming chip 6 and the discharge channel forming chip 12 in a specific geometrical relationship with respect to each other, the bolt 26 penetrating through holes provided on the upper pressing plate 2, the separation channel forming plate 8 of the separation channel forming chip 6, the discharge channel forming plate 14 of the channel forming chip 12, and the lower pressing plate 4, and a nut for fixing the bolt are used. The separation channel forming chip 6 is disposed at a position directly below the upper pressing plate 2, and the discharge channel forming chip 12 is disposed at a position directly above the lower pressing plate 4.

The through hole 8a provided on the separation channel forming plate 8 has one opening (upper opening in the diagram) closed by the upper pressing plate 2, and the other opening closed by the separation membrane 10, so as to constitute the separation channel 3. The through hole 20 of the separation channel forming plate 8 leads to one end portion of the separation channel 3 and constitutes an inlet port for injecting a carrier fluid or a sample (hereinafter, referred to as the inlet port 20). The through hole 22 of the separation channel forming plate 8 leads to the other end portion of the separation channel 3 and constitutes an outlet port for allowing a fluid to flow out from the separation channel 3 (hereinafter, referred to as the outlet port 22). The through hole 24 of the separation channel forming plate 8 leads to an intermediate portion between one end portion and the other end portion of the separation channel 3 and constitutes an intermediate inlet port through which a fluid for forming a focus flow flows (hereinafter, referred to as the intermediate inlet port 24).

The entire lower surface of the separation membrane 10 of the separation channel forming chip 6 is supported by the support plate 16 of the discharge channel forming chip 12. The discharge channel 5 is provided below the support plate 16. The discharge channel 5 is provided along the separation channel 3. Further, although not shown in this diagram, the discharge channel forming chip 12 is also provided with a discharge port for discharging a fluid in the discharge channel 5 to the outside.

The separation membrane 10 and the support plate 16 are interposed between the separation channel 3 and the discharge channel 5. The separation membrane 10 has the property of allowing a carrier fluid (liquid) to pass through and not allowing sample particles to pass through. The support plate 16 has the property of allowing a carrier fluid that has passed through the separation membrane 10 to pass through while supporting the separation membrane 10. The O-ring 18 is sandwiched between the separation channel forming chip 6 and the discharge channel forming chip 12 to prevent a fluid flowing into the separation channel 3 from leaking to the surroundings.

The sample particles to be separated and the carrier fluid carrying the sample particles are introduced into the separation channel 3 via the inlet port 20. When the carrier fluid is introduced into the separation channel 3 through the inlet port 3, a flow (channel flow) in the direction toward the outlet port 22 side along the separation channel and a flow (cross flow) in the direction toward the discharge channel 5 by passing through the separation membrane 10 and the support plate 16 are generated. Further, after the sample particles are introduced into the separation channel 3, the carrier fluid is supplied from the intermediate inlet port 24, so that a flow (focus flow) in the direction opposite to the channel flow is generated in the separation channel 3.

Here, the flow path height of the separation channel 3 is the sum of the thickness of the separation channel forming plate 8 and the thickness of a bonded portion between the separation channel forming plate 8 and the separation membrane 10. When the separation channel forming plate 8 and the separation film 10 are bonded with an adhesive, the flow path height of the separation channel 3 changes depending on the thickness of an adhesive layer between the separation channel forming plate 8 and the separation film 10. However, it is difficult to reproduce the thickness of the adhesive layer between the separation channel forming plate 8 and the separation film 10 that is constant at all the time, and as a result, the reproducibility of the flow path height of the separation channel 3 becomes low. For this reason, the separation channel forming plate 8 and the separation film 10 may be bonded by a method other than the bonding with an adhesive.

Molecular adhesion is one of the methods of bonding the separation channel forming plate 8 and the separation membrane 10 without using an adhesive. In that case, as shown in FIG. 3, a method of interposing a silicone film 28 having a constant thickness between the separation channel forming plate 8 and the separation film 10 can be mentioned. In this method, the surface of the silicone film 28 is activated by, for example, corona discharge treatment, the separation channel forming plate 8 is adhered to one surface, and the separation film 10 is adhered to the other surface.

By bonding the separation channel forming plate 8 and the separation membrane 10 by molecular adhesion in this way, the reproducibility of the thickness of the bonded portion between the separation channel forming plate 8 and the separation membrane 10 is improved, and the reproducibility of the flow path height of the separation channel 3 is improved.

In the separation cell of the present embodiment, the separation channel forming chip 6 is a consumable item, and when the separation membrane 10 needs to be replaced, the separation channel forming chip 6 is replaced together. A relative geometrical relationship between the separation channel forming chip 6 and the upper pressing plate 2 and the discharge channel forming chip 12 is automatically determined by the positioning structure such as the bolt 26. Since the separation membrane 10 is fixed at a predetermined position in the flat surface provided with the through hole 8a of the separation channel forming plate 8, it is not necessary to align the separation membrane 10 alone.

In the field-flow fractionation device, the analysis is performed in a state where the space inside the O-ring 18 in the separation cell 2 is filled with the carrier fluid. That is, the analysis cannot be started from the start of the supply of the carrier fluid until the space inside the O-ring 18 is filled with the carrier fluid. For this reason, as the volume of the space inside the O-ring 18 is larger, the waiting time from the start of the supply of the carrier fluid to the start of analysis becomes longer.

In the separation cell of the present embodiment, since the separation membrane 10 is integrated with the separation channel forming plate 8 to constitute the separation channel forming chip 6, position displacement of the separation membrane 10 cannot occur. For this reason, even if the O-ring 18 is disposed at a position closest to the support plate 16, the separation membrane 10 cannot be disposed so as to overlap the O-ring 18 around the support plate 16. For this reason, the volume of the space inside the O-ring 18 can be made smaller than before. By reducing the volume of the space inside the O-ring 18, the waiting time from the start of the supply of the carrier fluid to the start of the analysis can be shortened, and the analysis efficiency can be improved.

### DESCRIPTION OF REFERENCE SIGNS

2: Upper pressing plate
3: Separation channel
4: Lower pressing plate
5: Discharge channel
6: Separation channel forming chip
8: Separation channel forming plate
8a: Through groove
10: Separation membrane
12: Discharge channel forming chip
14: Discharge channel forming plate
16: Support plate
17: Groove
18: O-ring
20: Through hole (inlet port)
22: Through hole (outlet port)
24: Through hole (intermediate inlet port)
26: Bolt
28: Silicone film

1. A separation cell for a field-flow fractionation device, the separation cell including a separation channel forming chip and a discharge channel forming chip, the separation cell comprising:
a separation channel forming plate that is provided on the separation channel forming chip and has a flat surface defining a separation channel having a longitudinal direction;
a discharge channel forming plate that is provided on the discharge channel forming chip and has a flat surface defining a discharge channel extending along a longitudinal direction of the separation channel;
a separation membrane that is provided on the flat surface defining the separation channel on the separation channel forming chip, the membrane being interposed between the separation channel and the discharge channel, the membrane having a size smaller than that of the separation channel forming plate and larger than that of the separation channel, the membrane being fixed to the separation channel forming plate to block the separation channel, the membrane configured for selectively allowing a carrier fluid to permeate therethrough;
a porous support plate provided on the flat surface defining the discharge channel on the discharge channel forming chip, the support plate having property of allowing the carrier fluid to permeate therethrough, the support plate having a size smaller than that of the discharge channel forming plate and equal to or larger than that of the separation membrane, the support plate being attached to block an opening of the discharge channel; and
a positioning structure for positioning the separation channel forming chip and the discharge channel forming chip in a specific geometrical relationship with respect to each other, wherein
the separation channel forming chip and the discharge channel forming chip are positioned in the specific geometrical relationship by the positioning structure, whereby the separation membrane is wholly supported by the support plate.

2. The separation cell according to claim 1, wherein the separation channel forming plate and the separation membrane are adhered by molecular adhesion.

3. The separation cell according to claim 2, wherein a silicone film is interposed between the separation channel forming plate and the separation film.

4. The separation cell according to claim 1, wherein the positioning structure includes through holes for bolt penetration provided on each of the separation channel forming plate and the discharge channel forming plate and bolts penetrating the through hole, and common bolts are allowed to penetrate the through holes of each of the separation channel forming plate and the discharge channel forming plate, so that the separation channel forming chip and the discharge channel forming chip are positioned in the specific geometrical relationship with respect to each other.
